(19) United States
(12) Patent Application Publication
(10) Pub. No.: US 2015/0187056 A1
(43) Pub. Date: Jul. 2, 2015

(54) ELECTRONIC APPARATUS AND IMAGE PROCESSING METHOD

(71) Applicant: Kabushiki Kaisha Toshiba, Tokyo (JP)

(72) Inventors: Midori Nakamae, Hino Tokyo (JP); Eiki Obara, Hiki Saitama (JP)

(21) Appl. No.: 14/516,344

(22) Filed: Oct. 16, 2014

(30) Foreign Application Priority Data
Dec. 26, 2013 (JP) 2013-268628

(51) Int. Cl. G06T 5/00

(52) U.S. Cl. CPC G06T 5/005; G06T 2207/10004; G06T 2207/20224

(57) ABSTRACT

According to one embodiment, an electronic apparatus includes a processor and an extraneous object processor. The processor generates a first image from a camera and generates a second image corresponding to the first image by the camera based on setting data related to the first image. The extraneous object processor generates a corrected image by replacing a first area comprising an extraneous object in the first image with a second area in the second image, the second area corresponding to the first area.

### CROSS-REFERENCE TO RELATED APPLICATIONS

This application is based upon and claims the benefit of priority from Japanese Patent Application No. 2013-268628, filed Dec. 26, 2013, the entire contents of which are incorporated herein by reference.

### FIELD

Embodiments described herein relate generally to an electronic apparatus which processes an image, and an image processing method applied to the apparatus.

### BACKGROUND

Recently, various electronic devices by which images (photos) can be captured have become widespread. For example, personal computers, PDAs, feature phones, and smartphones which are equipped with a camera, and digital cameras are widely used. Most of these electronic devices have a live-view function by which an image captured at the current camera position and posture is displayed on the display screen of the device in real time. Users can take a picture of a desired scene by confirming the image displayed on the screen by means of the live-view function.

In most of the electronic devices equipped with a camera, a lens for photographing is provided on the back surface of the device. Since a user takes a picture by means of the above live-view function, in many cases, the user does not recognize the position of the lens when taking a picture. Further, the user can use the screen in both a portrait and a landscape orientation by changing the orientation of the electronic device. However, this change may make it more difficult to recognize the position of the lens.

Because the user takes a picture without recognizing the position of the lens, fingers with which the electronic device is held sometimes intrude into the image to be captured. In particular, when a picture is taken in haste, in many cases, the user does not notice that his/her fingers or extraneous objects appear in the image. However, a picture taken in a hurry has a high possibility of capturing an important moment for the user. The intrusion of an extraneous object into the picture makes the user feel very stressful.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective illustration showing an appearance of an electronic apparatus according to an embodiment.

FIG. 2 is an exemplary block diagram showing a system configuration of the electronic apparatus of the embodiment.

FIG. 3 is an exemplary block diagram showing a function configuration of an image processing program executed by the electronic apparatus of the embodiment.

FIG. 4 is a view showing an example of a screen when an extraneous object is included in a first image photographed by the electronic apparatus of the embodiment.

FIG. 5 is a view showing an example of a second image photographed again by the electronic apparatus of the embodiment.

FIG. 6 is a view showing an example of a screen including an image from which an extraneous object is removed, the screen being displayed by the electronic apparatus of the embodiment.

FIG. 7 is a flowchart showing an example of the procedure of an extraneous object detection process executed by the electronic apparatus of the embodiment.

FIG. 8 is a flowchart showing an example of the procedure of an extraneous object removal process executed by the electronic apparatus of the embodiment.

### DETAILED DESCRIPTION

Various embodiments will be described hereinafter with reference to the accompanying drawings.

In general, according to one embodiment, an electronic apparatus includes a processor and an extraneous object processor. The processor is configured to generate a first image from a camera and to generate a second image corresponding to the first image by the camera based on setting data related to the first image. The extraneous object processor is configured to generate a corrected image by replacing a first area comprising an extraneous object in the first image with a second area in the second image, the second area corresponding to the first area.

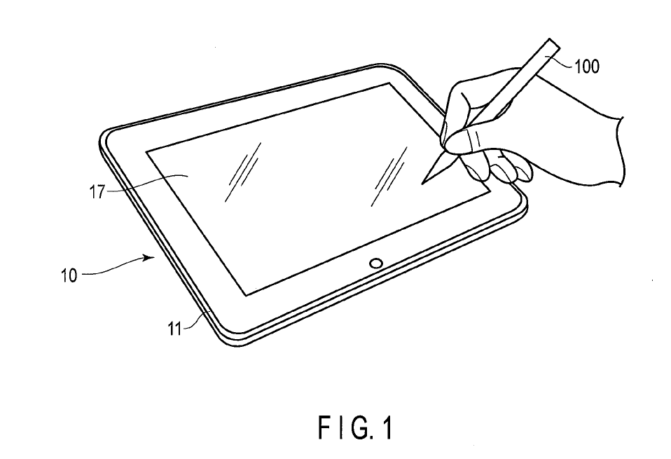

FIG. 1 is a perspective illustration showing an appearance of an electronic apparatus according to an embodiment. This electronic apparatus can be realized as a tablet computer, a notebook-type personal computer, a smartphone, a PDA, or an embedded system in various types of electronic apparatus such as a digital camera. In the following description, it is assumed that this electronic apparatus is realized as a tablet computer 10. The tablet computer 10 is a portable electronic apparatus which is also called a tablet or a slate computer. As shown in FIG. 1, the tablet computer 10 includes a main body 11 and a touch screen display 17. The touch screen display 17 is attached to the top surface of the main body 11 in such a way that the touch screen display 17 overlaps the top surface of the main body 11.

The main body 11 includes a housing having a thin box shape. A flat panel display and a sensor configured to detect a contact position of a stylus or a finger on the screen of the flat panel display are incorporated into the touch screen display 17. The flat panel display may be, for example, a liquid crystal display (LCD). As the sensor, for example, a capacitive touch panel or an electromagnetic induction digitizer may be used.

A lens of a camera module for taking a picture from the back surface of the main body 11 is provided on the back surface of the main body 11.

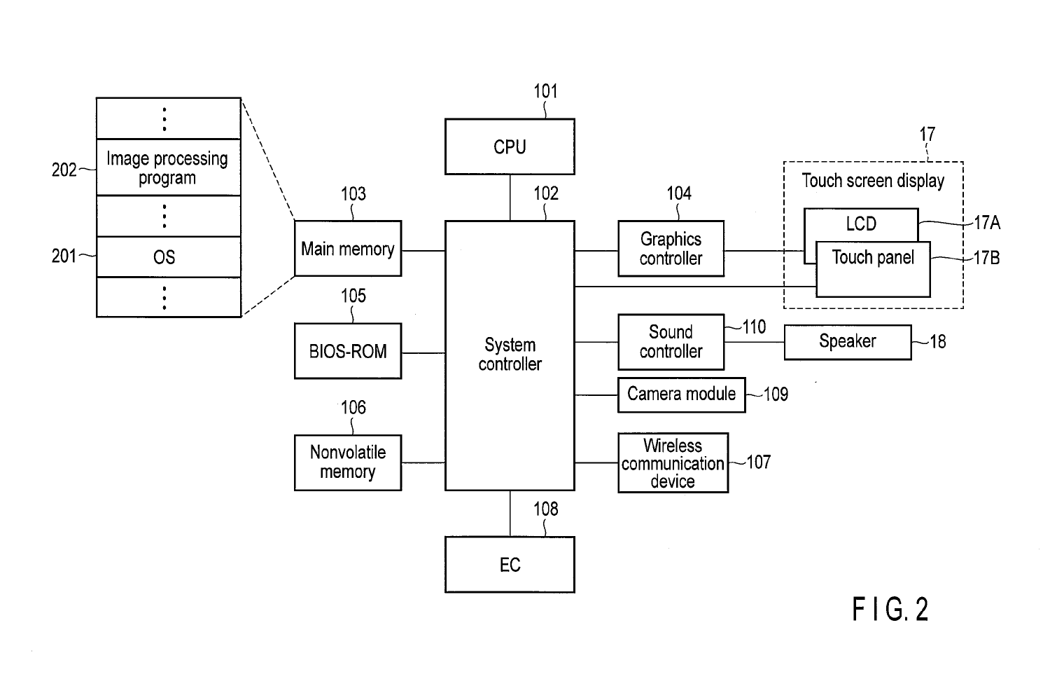

FIG. 2 shows a system configuration of the tablet computer 10.

The tablet computer 10 includes, as shown in FIG. 2, a CPU 101, a system controller 102, a main memory 103, a graphics controller 104, a BIOS-ROM 105, a nonvolatile memory 106, a wireless communication device 107, an embedded controller (EC) 108, a camera module 109, and a sound controller 110, etc.

The CPU 101 is a processor configured to control operations of various components of the tablet computer 10. The CPU 101 executes various types of software loaded into the main memory 103 from the nonvolatile memory 106 which is a storage device. The software includes an operating system (OS) 201 and various types of application programs. The application programs include an image processing program 202. The image processing program 202 is configured to, for example, remove an extraneous object in the image captured by using the camera module 109.

The CPU 101 also executes a basic input/output system (BIOS) stored in the BIOS-ROM 105. The BIOS is a program for hardware control.

The system controller 102 is an apparatus configured to connect a local bus of the CPU 101 to various components. The system controller 102 includes a memory controller which access-controls the main memory 103. The system controller 102 is also configured to communicate with the graphics controller 104 through a serial bus conforming to the PCI EXPRESS standard, etc.

The graphics controller 104 is a display controller configured to control an LCD 17A used as the display monitor of the tablet computer 10. Display signals generated by the graphics controller 104 are transmitted to the LCD 17A. The LCD 17A displays a screen image based on the display signals. A touch panel 17B is provided on the LCD 17A.

The system controller 102 is further configured to communicate with the sound controller 110. The sound controller 110 is a sound source device, and outputs audio data to be reproduced to a speaker 18.

The wireless communication device 107 is a device configured to execute wireless communications by means of a wireless LAN or 3G mobile communications, etc. The EC 108 is a one-chip microcomputer including an embedded controller for power management. The EC 108 is configured to turn the tablet computer 10 on or off depending on an operation of a power button by a user.

The camera module 109 includes an optical system including one or more lenses, and a solid-state image pickup device having a charge-coupled device (CCD) type or a complementary metal oxide semiconductor (CMOS) type, etc. The camera module 109 converts electrical signals (analog image signals) which are generated by the solid-state image pickup device and correspond to an image of an object formed in the optical system into digital image signals.

The camera module 109 is configured to generate an image file having a predetermined format by using digital image signals. Various types of picture data such as the date and time the picture is taken and setting data may be added to the image file. The camera module 109 stores the resulting image file in the main memory 103 or the nonvolatile memory 106. The camera module 109 may store the resulting image file in an external storage medium such as an SD card or a USB flash memory.

The camera module 109 takes a picture in response to a user's operation of, for example, touching (tapping) a predetermined button (graphical object) displayed on the screen of the touch screen display 17 or pressing a predetermined hardware button provided in the computer 10. The camera module 109 is also configured to take consecutive pictures such as a moving picture.

When an object is photographed by using the camera module 109, the picture taken may include an extraneous object. For example, this extraneous object is a finger with which the tablet computer 10 is held. For example, the finger appears in the picture since the user does not recognize the position of the lens provided on the back surface of the tablet computer 10.

When an extraneous object is included in a first image which is captured, this embodiment suggests a user to take a picture again in order to generate an image from which the extraneous object in the first image is removed by exploiting the first image and a second image obtained by the retaking.

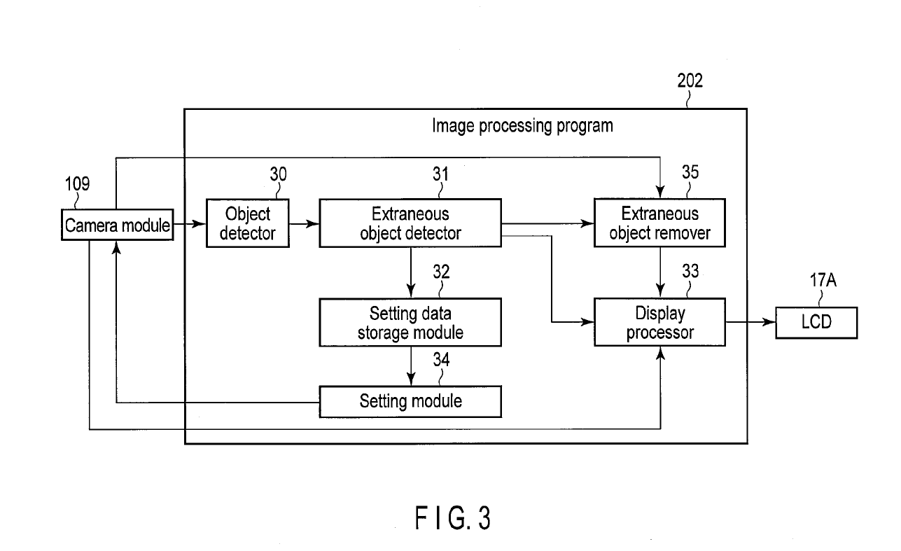

FIG. 3 shows an example of a function configuration of the image processing program 202. The image processing program 202 has various types of image processing functions such as extraction of particular data from an image and composite of images. For example, the image processing program 202 is configured to remove an extraneous object by exploiting the second image when the extraneous object is included in the first image. The image processing program 202 includes, for example, an object detector 30, an extraneous object detector 31, a setting data storage module 32, a display processor 33, a setting module 34, and an extraneous object remover 35.

The image processing program 202 receives image data generated by the camera module 109 and processes the image data. The display processor 33 is configured to display the image which is photographed by the camera module 109 as a preview (live-view) on the screen of the LCD 17A in real time. The user conducts an operation for instructing photographing (for example, an operation of pressing a predetermined button) when the image to be captured (stored) is displayed on the screen while the user confirms the preview display. In response to this operation by the user, the camera module 109 generates image data to be stored. The camera module 109 may temporarily store the resulting image data in the main memory 103, etc.

The object detector 30 detects the area(s) of one or more objects (substance) in the first image when the data of the first image is generated in response to the user's operation for instructing picture taking (storage of the image displayed as a preview) by using the tablet computer 10. The object detector 30 detects, for example, the area of the image of a person in the first image. For example, the object detector 30 detects the area of a person by calculating the feature amounts of the first image, and detecting the area, which has the feature amount similar to the prepared sample of the feature amount of the image of a person, from the first image. The sample of the feature amount of the image of a person is feature amount data obtained by statistically processing the feature amount of the image of each of many persons.

In addition, the object detector 30 detects the area of an object (substance) other than a person from the first image. The object detector 30 detects, for example, the outline form (edge) of an object, and detects the areas of various types of objects other than persons based on the outline forms. This kind of area of an object other than a person includes, for example, the area of an extraneous object such as a user's finger with which the tablet computer 10 is held.

The extraneous object detector 31 analyzes the spectral distribution of the data of the first image, and detects the area of an extraneous object included in the first image (hereinafter, also referred to as the first area) based on the positions and power spectral values of objects in the first image. For example, when an object having a low frequency power spectrum is located in the end portion of the first image, and an object having a high frequency power spectrum is located in the central portion of the first image, the extraneous object detector 31 determines that the object located in the end portion of the first image is extraneous. For example, the object located in the end portion of the first image is defined as follows: at least a part of the object is included in the area of a predetermined percentage (for example, 30 percent) from the margin of the first image, or at least a part of the object makes contact with the margin of the first image. Moreover, for example, the object located in the central portion of the first image is defined as follows: at least a part of the object is included in the area of a predetermined percentage (for example, 30 percent) from the center of the first image, or includes the center of the first image.

The extraneous object detector 31 may detect a flesh-colored area by analyzing the data of the first image by exploiting the prepared data of flesh colors of various types of race. When a flesh-colored area is detected in the end portion of the first image, the extraneous object detector 31 determines that the object which has a low power spectrum, has a flesh color and is located in the end portion of the first image is the area of a finger of the user (photographer), by combining the flesh-colored area with the above-described positions and power spectral values of objects in the first image. In other words, the extraneous object detector 31 determines that this object is an extraneous object. In this manner, it is possible to detect only the extraneous object that is a user's finger.

When an extraneous object is included in the first image, the setting data storage module 32 stores the setting data at the time the first image is captured. The setting data includes various types of values (parameters) such as the shutter speed, aperture (F-number), ISO sensitivity, and zoom value at the time of taking a picture.

When an extraneous object is included in the first image, the display processor 33 prompts the user to take a picture again. For example, the display processor 33 displays the photographed (stored) first image and a message which prompts the user to retake a picture on the screen. The display processor 33 may display the area corresponding to the detected extraneous object in the first image in such a way that this area is distinguished from the other area. For example, the display processor 33 displays the area corresponding to the extraneous object by surrounding the area with a frame line, or displays the area in a different color or transparency from the other area. In this manner, the user can easily determine whether the area, which is the cause of the prompting of retaking, is an extraneous object. The message for prompting the user to take a picture again may be output by the speaker 18, etc., as sound or voice.

When the user selects the execution of retaking, the camera module 109 in which the setting data at the time of capturing the first image is set generates the second image corresponding to the first image. Specifically, when the user selects the execution of retaking, the setting module 34 applies the setting data at the time of capturing the first image stored by the setting data storage module 32, to the camera module 109 in such a way that the second picture to be taken is as similar to the first image as possible.

Further, when the user selects the execution of retaking, the display processor 33 displays the preview display of the image photographed by the camera module 109 and the first image (the image containing an extraneous object) whose brightness and transparency, etc., are changed on the screen in such a way that the preview display and the first image overlap each other. For example, the display processor 33 displays the first image as a transparent image superimposed on the preview image photographed by the camera module 109. The user can conduct an operation for instructing the photographing of the second image with the same structural outline as the first image (for example, at the same picture-taking position and posture as the first image) by using the displayed first image as a navigation image. By this structure, in the camera module 109, the second image which has the same (a similar) structural outline as (to) the first image is generated. The camera module 109 may temporarily store the data of the resulting second image in the main memory 103, etc.

When the user moves the tablet computer 10 (the lens of the camera module 109) for the purpose of overlapping the structural outline of the image displayed as a preview and the structural outline of the navigation image (first image) each other, and the degree of similarity between the image displayed as a preview and the navigation image (first image) is equal to or higher than a threshold value (in other words, when the degree of similarity between the images becomes or exceeds the threshold value), the display processor 33 may request the camera module 109 to capture (store) the second image. The camera module 109 generates the second image in response to the request. By this structure, it is possible to more easily obtain the second image photographed with the structural outline that is similar to the first image.

Next, the extraneous object remover 35 generates an image from which an extraneous object is removed by replacing the area (first area) of the extraneous object in the first image with the area (second area) of the corresponding position in the second image by exploiting the first image and the second image. The extraneous object remover 35 may temporarily store the resulting image from which the extraneous object is removed in the main memory 103. The extraneous object remover 35 may generate images by retaking more than two images which are the first image and the second image, and generate an image from which the extraneous image is removed by using the retaken images.

In order to generate an image from which an extraneous object is removed, the extraneous object remover 35 may use an image captured by another user instead of using the second image generated by retaking. For example, the extraneous object remover 35 obtains an image photographed with a structural outline that is similar to the first image (at a similar picture-taking position and posture) from images obtained from the Internet and a cloud server by exploiting various types of metadata added to the images such as the location data (for example, position data using GPS), the caption related to an object and the date and time of taking the picture. The extraneous object remover 35 replaces the area of an extraneous object in the first image with the area of the corresponding position in the obtained image by exploiting the first image and the obtained image, thereby generating an image from which the extraneous object is removed.

When an extraneous object is included in the first image, but the user does not select the execution of retaking, the extraneous object remover 35 may generate an image from which the extraneous object is removed by exploiting the first image. The extraneous object remover 35 generates the image from which the extraneous object is removed by changing the pixel value of the pixel in the area of the extraneous object by exploiting a plurality of pixel values of a plurality of pixels in an area (third area) related to the area of the extraneous object in the first image. For example, when the area of the extraneous object is located at the left end of the first image, the extraneous object remover 35 generates an image from which the extraneous object is removed by exploiting the area which is located at the right end and which does not include the extraneous object. Further, for example, the extraneous object remover 35 generates an image from which the extraneous object is removed by changing the pixel value of the pixel in the area of the extraneous object by exploiting the most frequent pixel value (color) among a plurality of pixel values of a plurality of pixels in the adjacent (surrounding) area of the extraneous object.

When retaking is not begun within a threshold value time (for example, one minute) after the user is prompted to retake a picture, retaking may be stopped for the following reason: there is a possibility that the long time passage from the capturing of the first image makes it difficult to take a picture with a similar structural outline since the weather or landscape in the shooting place is changed. In this case, the same procedure as the case where the user does not select the execution of retaking as described above is conducted.

Next, the display processor 33 displays the image from which the extraneous object is removed, and an object (for example, a button) for selecting whether the image should be stored on the screen. When the user chooses to store the image, the extraneous object remover 35 stores the data of the image from which the extraneous object is removed (an image file having a predetermined format) in a memory medium (for example, the nonvolatile memory 106). The extraneous object remover 35 prevents the extraneous image file from remaining in the memory by deleting the data of the second image from the memory. The data of the second image may be stored in the memory medium as an image file in response to an operation by the user.

When the user chooses not to store the image, the extraneous object remover 35 deletes the data of the image from which the extraneous object is removed and the data of the second image from the memory.

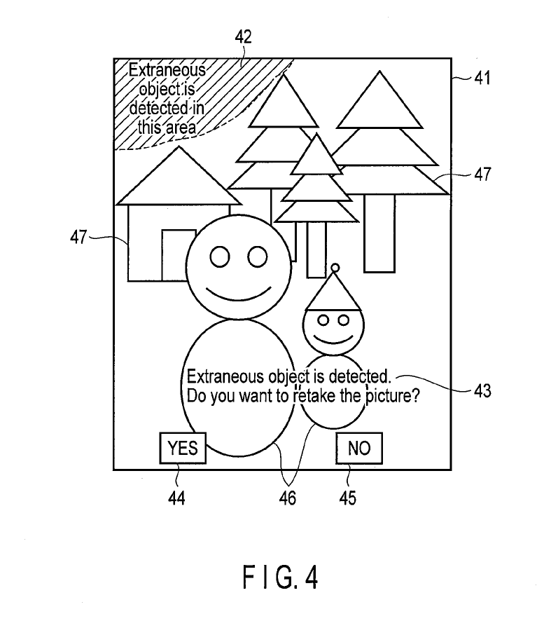

By reference to FIGS. 4 to 6, this specification explains a specific example of generation of an image from which an extraneous object is removed.

FIG. 4 shows an example of a screen in a case where an extraneous object 42 is included in a first image 41 photographed by using the camera module 109. The captured (generated) first image 41 is displayed on this screen. In the first image 41, moving objects 46 such as a person and an automobile, and stationary objects 47 such as a building, a tree and a road are captured. The area 42 of the extraneous object in the first image 41 is displayed in such a way that the area 42 is distinguished from the other area. A message indicating that the area 42 is the area of the extraneous object may be displayed in the area 42 of the extraneous object.

Moreover, a message 43, which prompts the user to retake a picture for removing the extraneous object, is displayed on the screen. Further, a YES button 44 for choosing to retake a picture and a NO button 45 for choosing not to retake a picture are provided on the screen.

For example, the user chooses either the YES button 44 or the NO button 45 by tapping the touch screen display 17. When the YES button 44 is chosen, the second image is captured by using the camera module 109. The second image is used for removing the area 42 of the extraneous object in the first image 41.

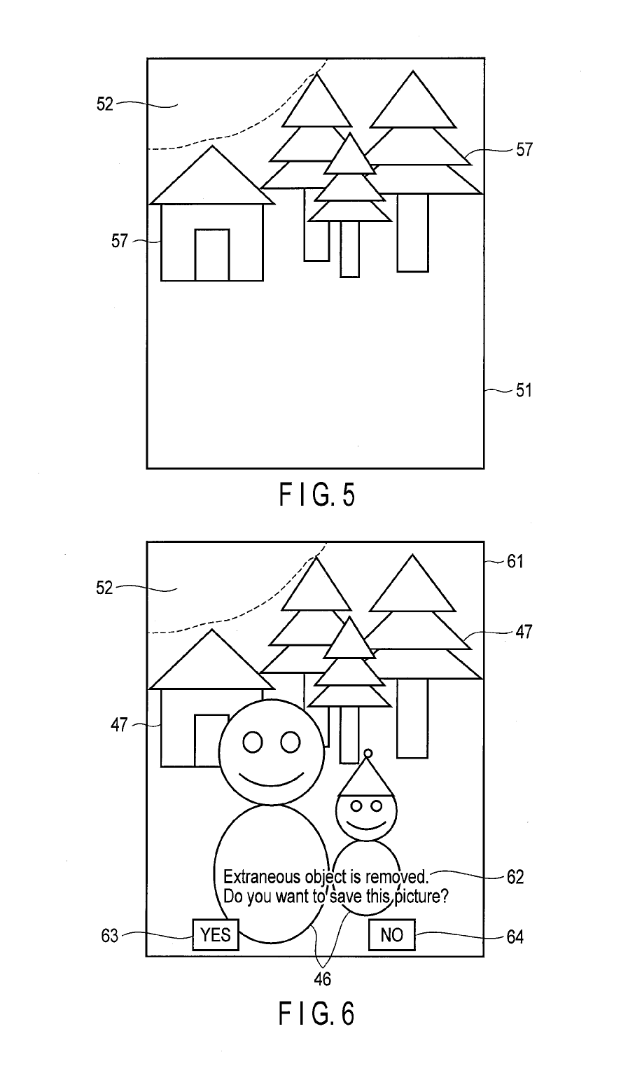

FIG. 5 shows an example of a second image 51 photographed by using the camera module 109. The second image 51 is an image captured (generated) by using the camera module 109 in which the setting data at the time of capturing the first image 41 is set. Since the second image 51 is used for removing the area 42 of the extraneous object in the first image 41, the second image 51 is preferably as similar to the first image 41 as possible (for example, the second image 51 is preferably captured with the same or a similar structural outline from the same or a similar position).

However, the moving objects 46 in the first image 41 might move after the first image 41 is captured. Therefore, for example, the user takes a picture including as a large part of the stationary objects 47 in the first image 41 as possible as the second image 51. Specifically, the user captures the second image 51 by using the camera module 109 in which the setting data at the time of capturing the first image 41 is set in the same (or a similar) position and posture as the photographed first image 41.

When retaking is requested (the YES button 44 is chosen), the display processor 33 may display the image photographed by using the camera module 109; in other words, the image currently captured by the camera module 109, as a preview on the screen, and may display the first image 41 as a transparent image (in other words, with a high transparency) on the image displayed as a preview. The user adjusts the position and posture of the camera module 109 (lens) in such a way that the displayed first image 41 fits the image displayed as a preview, and conducts an operation for instructing the capturing of the second image 51. When the moving objects 46 are included in the first image 41, the user may adjust the position and posture of the camera module 109 (lens) in such a way that the portions of the stationary objects 47 in the first image 41 fit the portions of the stationary objects in the image displayed as a preview.

The extraneous object remover 35 generates an image from which the extraneous object is removed by exploiting the first image 41 and the second image 51.

On the screen shown in FIG. 6, an image 61 from which the extraneous object is removed is displayed. The image 61 is generated by replacing the area 42 of the extraneous object in the first image 41 with the area 52, which corresponds to the area 42, in the second image 51. In the image 61, no process is applied to the areas other than the area 42 of the extraneous object (for example, the areas of the moving objects 46 and the areas of the stationary objects 47). On this screen, a message 62 for confirming whether the displayed image 61 should be stored is displayed. Further, an YES button 63 for choosing to save the image and a NO button 64 for choosing not to save the image are provided on this screen.

The user chooses either the YES button 63 or the NO button 64 by, for example, a tap operation by using the touch screen display 17. When the YES button 63 is chosen, the image 61 from which the extraneous object is removed is stored. When the NO button 64 is chosen, the image 61 and the second image 51 are discarded.

When the user captures the first image 41, the extraneous object detector 31 may determine whether an extraneous object such as a user's finger is included in the preview image. When an extraneous object is included in the preview image, the user is warned by an alert sound, audio announcement, message display, etc. When the user avoids an extraneous object such as a finger before photographing the first image 41, the above-described image process for removing the extraneous object is unnecessary.

In the above description, the structure of removing the detected extraneous object 42 is explained. However, an image from which some of the objects are removed may be generated based on the priority of each object. Specifically, the object detector 30 sets the priority for each object detected from the first image 41. For example, the object detector 30 sets the highest priority for the object detected as a person, and sets higher priorities for the objects which are not a person in the order that is closer to the area of the person.

The extraneous object remover 35 generates an image from which the area of an object, which has a lower priority than a predetermined value in the first image, is removed by replacing the area of the object 41 with the area of the corresponding position in the second image 51 by exploiting the first image 41 and the second image 51. The extraneous object remover 35 can generate a plurality of images by changing the predetermined value to various values. For example, the extraneous object remover 35 generates two images as follows. In one of them, only the object having the highest priority remains, and all of the other objects are deleted. In the other image, only the object having the lowest priority is deleted.

The display processor 33 displays the plurality of resulting images on the screen. In this manner, the user can select the image to be stored from the plurality of displayed images.

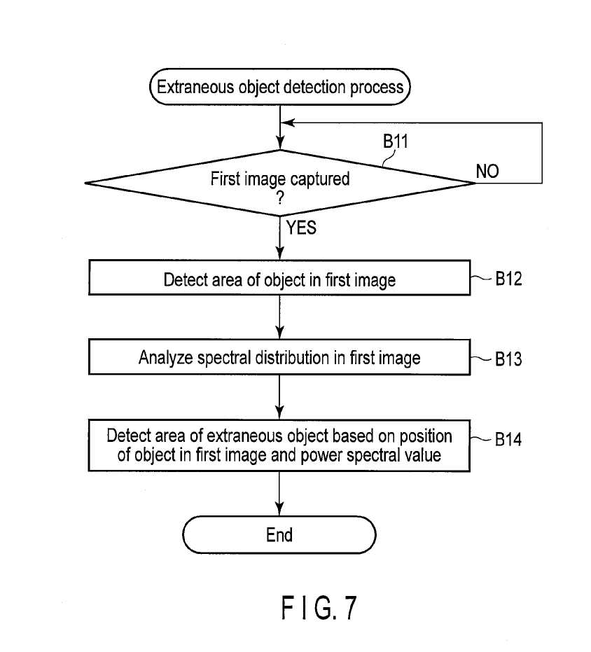

Next, this specification explains an example of the procedure of an extraneous object detection process executed by the tablet computer 10 by reference to the flowchart of FIG. 7.

First, the object detector 30 determines whether the first image 41 is photographed (block B11). When the first image 41 is not captured (No in block B11), the procedure returns to block B11 in order to determine again whether the first image 41 is photographed.

When the first image 41 is captured (Yes in block B11), the object detector 30 detects the area(s) of one or more objects in the first image 41 (block B12). The extraneous object detector 31 analyzes the spectral distribution of the first image 41 (block B13). For example, the extraneous object detector 31 obtains the spectral distribution of the first image 41 by applying discrete Fourier transform to the data of the first image 41.

Next, the extraneous object detector 31 detects the area of an extraneous object based on the position and power spectral value of the object in the first image 41 (block B14). For example, when an object having a low frequency power spectrum is located in the end portion of the first image 41, and an object having a high frequency power spectrum is located in the central portion of the first image 41, the extraneous object detector 31 determines that the object located in the end portion of the first image 41 is extraneous.

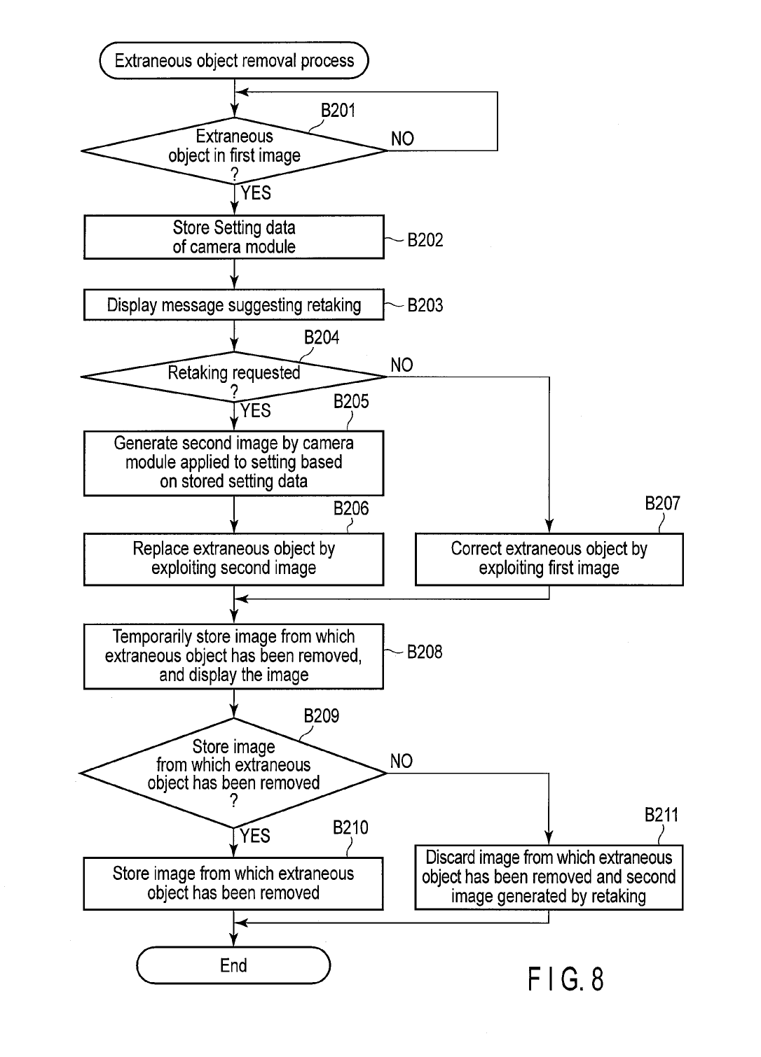

The flowchart of FIG. 8 shows an example of the procedure of an extraneous object removal process executed by the tablet computer 10.

First, the setting data storage module 32 determines whether there is an extraneous object in the first image 41 (block B201). When there is no extraneous object in the first image 41 (No in block B201), the procedure goes back to block B201 in order to determine whether there is an extraneous object in the newly captured image.

When there is an extraneous object in the first image 41 (Yes in block B201), the setting data storage module 32 stores the setting data of the camera module 109 at the time of capturing the first image 41 (block B202). The display processor 33 displays the first image 41 including the extraneous object and the message 43 suggesting to the user that a picture should be retaken on the screen of the LCD 17A. On this screen, for example, a button by which the user chooses whether an image should be captured again is displayed.

Next, the setting module 34 determines whether retaking is requested (block B204). When retaking is requested (Yes in block B204), the setting module 34 sets parameters (shutter speed, aperture [F-number], ISO sensitivity and zoom ratio, etc.,) of the camera module 109 based on the stored setting data, and the camera module 109 generates the second image 51 (block B205). The extraneous object remover 35 generates the image 61 from which an extraneous object is removed by replacing the area 42 of the extraneous object in the first image 41 with the area, which corresponds to the area 42 of the extraneous object, in the second image 51 by exploiting the second image 51 generated by retaking (block B206).

When retaking is not requested (No in block B204), the extraneous object remover 35 corrects the area 42 of the extraneous object by exploiting the areas other than the area 42 of the extraneous object in the first image 41 (block B207). For example, the areas used for this correction are areas related to the area 42 of the extraneous object. The extraneous object remover 35 changes the pixel value of the pixel included in the area 42 of the extraneous object to, for example, the most frequent pixel value among pixel values corresponding to pixels in the area which is neighboring the area 42 of the extraneous object. When the area 42 of the extraneous object is located at the left end of the first image 41, the extraneous object remover 35 may change the pixel value of the pixel in the area 42 to, for example, the pixel value of the pixel in the area located at the right end of the first image 41.

The extraneous object remover 35 temporarily stores the image 61 from which the extraneous object is removed (or the image 61 in which the extraneous object is corrected), and the display processor 33 displays the image 61 on the screen (block B208).

As explained above, according to this embodiment, it is possible to easily obtain an image from which an extraneous object is removed. The camera module 109 generates the first image 41, and generates the second image 42 corresponding to the first image 41 in a state where the setting data at the time of capturing the first image 41 is applied. The extraneous object remover 35 generates the image 61 from which the extraneous object is removed by replacing the first area 42 of the extraneous object in the first image 41 with the second area 52, which corresponds to the first area 42, in the second image 51. In this manner, the image 61 from which the extraneous object is removed is generated by exploiting the second image 51 captured with the same setting as the first image 41. Thus, a natural and clear image can be obtained.

All the procedures in the present embodiment, which have been described with reference to flowcharts of FIGS. 7 and 8, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to generate a first image from a camera and to generate a second image corresponding to the first image by the camera based on setting data related to the first image; and
an extraneous object processor configured to generate a corrected image by replacing a first area comprising an extraneous object in the first image with a second area in the second image, the second area corresponding to the first area.

2. The electronic apparatus of claim 1, wherein the second image is captured with a structural outline similar to the first image.

3. The electronic apparatus of claim 1, further comprising a display processor configured to display a preview image captured by the camera on a screen, and to display the first image as a transparent image on the preview image when the first image comprises the first area.

4. The electronic apparatus of claim 3, wherein the processor is configured to generate the second image when a degree of similarity between the preview image and the first image is equal to or higher than a threshold.

5. The electronic apparatus of claim 1, wherein the extraneous object processor is configured to further generate the corrected image from which the extraneous object is removed by changing a pixel value of a pixel in the first area by using pixel values of pixels in the third area related to the first area.

6. The electronic apparatus of claim 5, wherein
the third area is adjacent to the first area, and
the extraneous object processor is configured to change the pixel value of the pixel in the first area by exploiting a most frequent pixel value among the pixel values of the pixels in the third area.

7. The electronic apparatus of claim 1, further comprising an extraneous object detector configured to detect the first area based on a power spectrum corresponding to the first image.

8. The electronic apparatus of claim 1, further comprising an extraneous object detector configured to detect a flesh-colored area in the first image, and to detect the first area based on a power spectrum corresponding to the first image and the flesh-colored area.

9. An image processing method for an electronic apparatus comprising:
generating a first image from a camera and generating a second image corresponding to the first image by the camera based on setting data related to the first image; and
generating a corrected image by replacing a first area comprising an extraneous object in the first image with a second area in the second image, the second area corresponding to the first area.

10. A computer-readable, non-transitory storage medium having stored thereon a program which is executable by a computer, the program controlling the computer to execute functions of:
generating a first image from a camera and generating a second image corresponding to the first image by the camera based on setting data related to the first image; and
generating a corrected image by replacing a first area comprising an extraneous object in the first image with a second area in the second image, the second area corresponding to the first area.
